(19) United States
(12) Patent Application Publication
(10) Pub. No.: US 2013/0022508 A1
(43) Pub. Date: Jan. 24, 2013

(54) SYSTEM FOR ENHANCED RECOVERY OF TANGENTIAL ENERGY FROM AN AXIAL PUMP IN A LOOP REACTOR

(71) Applicants: Ronald Sylvio LeBoeuf, Merrimack, NH (US); Donald Paul Russell, Kingston, NH (US)

(72) Inventors: Ronald Sylvio LeBoeuf, Merrimack, NH (US); Donald Paul Russell, Kingston, NH (US)

(73) Assignee: FLOWSERVE MANAGEMENT COMPANY, Irving, TX (US)

(21) Appl. No.: 13/554,082

(22) Filed: Jul. 20, 2012

Related U.S. Application Data
(60) Provisional application No. 61/510,095, filed on Jul. 21, 2011.

(51) Int. Cl. B01J 19/18; F04D 3/00

(52) U.S. Cl. 422/132; 417/321

(57) ABSTRACT

An axial pump system cooperative with an elbow or other pipe section improves conversion of tangential to axial flow of a slurry flowing through a loop reactor by including both primary and secondary outlet guide vanes in the pipe section. The secondary guide vanes have “see through” access from the outlet end of the pipe section, while the primary guide vanes have “see through” access from the inlet side of the pipe section. Pump energy efficiency is improved, and friction of polymer particles on the reactor loop and pump sidewalls is reduced, thereby reducing the amount of polymer decay and increasing the percentage of useable and saleable product obtained from the reactor. Guide vanes can be straight or curved. Curved guide vanes can have inlet angles approximating the absolute flow angle of the fluid, and/or outlet angles approximating 0 degrees relative to the meridianal axis of the pipe section.

### RELATED APPLICATIONS

This application claims the benefit of U.S. Provisional Applications No. 61/510,095, filed Jul. 21, 2011, which is herein incorporated by reference in its entirety for all purposes.

### FIELD OF THE INVENTION

The invention relates to slurry polymerization in a liquid medium, and more particularly, to pumping apparatus for a loop reactor used for slurry polymerization.

### BACKGROUND OF THE INVENTION

Polyolefins such as polyethylene and polypropylene may be prepared by particle form polymerization, also referred to as slurry polymerization. With reference to FIG. 1, in this technique, feed materials such as monomer and catalyst are fed to a loop reactor 100, and a product slurry containing solid polyolefin particles in a liquid medium is taken off or withdrawn from the reactor 100.

With reference to FIG. 2, in a loop polymerization operation, a fluid slurry is circulated around the loop reactor 100 using one or more pumps 102, typically axial flow pumps having impellers 200 disposed within elbow sections 104 of the reactor 100 and drive shafts 202 extending through the curved walls of the elbow 104. As the volume of the reactor 100 and the solids concentration of the fluid slurry increase, the demands on the pump(s) also increase. In general, the flow rate, pressure, density, and viscosity of the fluid slurry must be considered in selecting and operating the loop reactor pump or pumps 102.

In addition to the concentration of the slurry, another factor affecting the solids concentration in the reactor is the fluid slurry circulation velocity. A higher slurry velocity for a given reactor diameter allows for a higher solids concentration, since the slurry velocity affects such limiting factors as heat transfer and reactor fouling due to polymer buildup in the reactor.

Until fairly recently, fluid slurries of olefin polymers in a diluent were generally limited to relatively low concentrations of reactor solids. Settling legs were used to concentrate the slurry to be withdrawn, so that at the exit of the settling legs, the slurry would have a higher solids concentration. As the name implies, settling occurs in the setting legs to increase the solids concentration of the slurry to be withdrawn.

By increasing the head and flow capability of the loop reactor circulating pump(s), a higher weight-percent of solids can be circulated in the reactor. With reference to FIG. 2, axial flow pumps 102 propel a liquid by using an impeller 200 to accelerate the liquid both axially and tangentially. The total pressure head generated by an axial flow pump 102 operating at a given speed is dependent on the sum of the axial component, frictional losses, and the portion of the tangential energy that can be converted into velocity in the axial direction.

With reference to FIG. 3, axial pump systems in loop reactors 100 frequently employ guide vanes 300 or diffusers adjacent to the pump impeller 200 to assist in redirecting the tangential flow velocity exiting the impeller 200 into axial motion. Such guide vanes can be “pre-swirl” guide vanes 300 which impose a counter-tangential component onto the flow on the inlet side of the impeller 200, which is then cancelled by the impeller 200. Instead or in addition to pre-swirl guide vanes 300, outlet guide vanes 302 can be installed on the outlet side of the impeller 200.

FIG. 4 presents a view of inlet pre-swirl guide vanes 300 emerging from a pipe 400 which has been disconnected from the elbow 104 containing the impeller 200 of the axial pump 102.

For economy of manufacture, outlet guide vanes 302 typically only extend axially into a pipe or elbow 104 a distance that is accessible from one end of the elbow 104. This approach simplifies construction and reduces cost by allowing attachment of the vanes 302 within the elbow by conventional welding methods. Furthermore, upsets in polymerization systems sometimes cause the elbows 104 to become packed with hardened polymer. This requires that guide vanes 302 be short enough to allow a user to “see through” the guide vanes 302 despite their design curvature. This allows a rod or other tool to be inserted through the vanes 302 so as to clear out any polymer solids if necessary.

This “see through” requirement is illustrated in FIGS. 5, 6A, and 6B, which are cylindrical projections of a set of guide vanes 302 onto a flat surface. With reference to FIG. 5, if the vanes 300 are flat, then the ability to “see through” the vanes will depend only on their width, their spacing, and the angle they make with the axis of the pipe. If the vanes 302 were parallel to the pipe axis, they could have any width and spacing, but of course they would not be effective in converting tangential flow to axial flow.

FIG. 6A illustrates a cylindrical projection of a set of curved guide vanes 302 as seen from an angle, where the vanes 302 have widths, spacing, and average directions approximately equal to the flat vanes of FIG. 5. The vane curvature will allow the vanes 302 of FIG. 6A to be more effective in converting tangential flow to axial flow as compared to the flat vanes of FIG. 5, but at the same time the curvature of the vanes 302 increases their overlap. FIG. 6B illustrates a projection of the same set of curved vanes 302 as FIG. 6A, seen along the axis of the pipe. Clearly, the curvature of the vanes 302 causes then to overlap and prevents “see through,” even though all other properties of the vanes 300 are approximately equal to the flat vanes of FIG. 5.

It can be seen, therefore, that the “see through” requirement places a significant limit on the widths of the outlet guide vanes 302 located in the elbow 104. Although the short “see through” guide vanes 302 typically used in the art provide some conversion of tangential fluid velocity to axial velocity, and thereby increase the pump efficiency, a substantial tangential component of the fluid flow typically still remains as the fluid emerges from the guide vanes and enters the bend in the elbow 104.

What is needed, therefore, is an improved design which will provide higher pump efficiency by recovering additional tangential fluid velocity generated by an axial pump in a loop reactor, while at the same time maintaining “see through” accessibility to and through all guide vanes for simplified welding during construction, maintenance between uses, and removal of clogged solids when necessary.

### SUMMARY OF THE INVENTION

In one general aspect of the present invention, an axial pumping system includes installation of one or more secondary discharge guide vanes at the outlet end of a pipe section containing a pump impeller, in addition to primary outlet guide vanes proximal to the impeller near the inlet end of the pipe section, so as to improve energy efficiency of the pumping system by converting additional tangential flow into axial flow while maintaining “see through” clearance between the guide vanes. The secondary guide vanes have “see through” access from the outlet end of the pipe section, while the primary guide vanes have “see through” access from the inlet side of the pipe section. In embodiments, the pipe section is an elbow pipe section. In other embodiments, the pipe section is straight, or has some other shape.

In some embodiments, the secondary guide vanes of the present invention are straight and redirect the fluid by acting as a barrier that disrupts the tangential fluid motion. In other embodiments, the guide vanes are curved or otherwise shaped. Various embodiments include shaped guide vanes having inlet angles approximating the absolute flow angle of the fluid, which is the actual direction of fluid flow due to both its axial [meridianal] and tangential velocities. Certain embodiments include shaped guide vanes having outlet angles approximating 0 degrees relative to the meridianal axis of the elbow.

It should be noted that the pipe section containing the impeller is sometimes referred to herein as a “pumping pipe section” or simply as a “pumping section,” so as to differentiate it from other sections of pipe in a loop reactor which do not contain a pump impeller. It should further be noted that while the pumping section is sometimes described in this paper as being an “elbow,” the invention applies equally to a pipe section which is a straight length of pipe, or to a pipe section having any other shape.

A second general aspect of the present invention is a loop reactor system which includes at least one “pumping section” as described above. When the pumping section is disassembled from the loop reactor, the secondary guide vanes of the pumping section have “see through” access from the outlet end of the pumping section, while the primary guide vanes have “see through” access from the inlet side of the pumping section. In some embodiments, a plurality of pumping sections are included in the loop reactor.

In both general aspects of the present invention, conversion by the present invention of additional tangential flow into axial flow increases the net axial flow velocity. The additional pump head recovered will be proportional to the square of the net velocity increase. Thus, there will be an increase in useful work from the pump without a change in power consumption, yielding an increased efficiency.

Furthermore, quick recovery of the tangential fluid velocity into axial flow by the present invention decreases the friction of polymer particles on the reactor loop and pump sidewalls, thereby reducing the amount of polymer decay and increasing the percentage of useable and saleable product obtained from the reactor.

One general aspect of the present invention is a pipe-mounted axial pump system that includes a pipe section having an inlet end and an outlet end, a pump shaft penetrating a wall of the pipe section, a pump motor located external to the pipe section and coupled to a proximal end of the pump shaft, a pump impeller mounted on a distal end of the pump shaft and positioned in an inlet region of the pipe section proximal to the inlet end of the pipe section, a primary guide vane assembly located within the pipe section and having see-through access from the inlet end of the pipe section, and a secondary guide vane assembly located within the pipe section and having see-through access from the outlet end of the pipe section. The primary guide vane assembly and the secondary guide vane assembly are configured so as to convert tangential flow created by rotation of the impeller into axial flow.

In embodiments, the pipe section includes at least one curved portion, and the pump shaft penetrates the wall of the pipe section in the curved portion. In some of these embodiments the pipe section is an elbow pipe section.

In various embodiments the secondary guide vane assembly includes at least one secondary guide vane that is flat.

In some embodiments, the secondary guide vane assembly includes at least one secondary guide vane that is curved. In some of these embodiments, the at least one secondary guide vane has an inlet angle which is approximately equal to an absolute flow angle of fluid propelled to the secondary guide vane by the impeller. In other of these embodiments the at least one secondary guide vane has an outlet angle that is approximately equal to a meridianal axis of the elbow at the secondary guide vane assembly.

Certain embodiments further include a pre-swirl guide vane assembly on an inlet side of the impeller. And in various embodiments the primary guide vane assembly is on an outlet side of the impeller.

Another general aspect of the present invention is a loop reactor polymerization system that includes a loop reactor including a plurality of pipe sections forming a closed loop of pipe, a pump shaft penetrating a wall of one of the pipe sections, the penetrated pipe section being referred to herein as the pumping section, the pumping section having an inlet end and an outlet end, a pump motor located external to the pumping section and coupled to a proximal end of the pump shaft, a pump impeller mounted on a distal end of the pump shaft and positioned in an inlet region of the pumping section proximal to the inlet end, rotation of the impeller by the pump motor and pump shaft causing fluid to be circulated through the loop reactor, a primary guide vane assembly located within the pumping section and having see-through access from the inlet end of the pumping section, and a secondary guide vane assembly located within the pumping section and having see-through access from the outlet end of the pumping section. The primary guide vane assembly and the secondary guide vane assembly are configured so as to convert tangential flow created by rotation of the impeller into axial flow.

In embodiments, the pumping section includes at least one curved portion, and the pump shaft penetrates the wall of the pumping section in the curved portion. In some of these embodiments the pumping section is an elbow pipe section.

In various embodiments the secondary guide vane assembly includes at least one secondary guide vane that is flat.

In certain embodiments the secondary guide vane assembly includes at least one secondary guide vane that is curved. In some of these embodiments the at least one secondary guide vane has an inlet angle which is approximately equal to an absolute flow angle of fluid propelled to the secondary guide vane by the impeller.

In some embodiments the at least one secondary guide vane has an outlet angle that is approximately equal to a meridianal axis of the elbow at the secondary guide vane assembly. Other embodiments further include a pre-swirl guide vane assembly on an inlet side of the impeller.

In various embodiments the primary guide vane assembly is on an outlet side of the impeller.

And in certain embodiments the system includes a plurality of pumping sections penetrated by pump shafts, each of the pump shafts being coupled to a corresponding pump motor external to the corresponding pumping section and an impeller in an inlet region proximal to an inlet end of the corresponding pumping section, each of the corresponding pumping sections containing a primary guide vane assembly having see-through access from the inlet end of the corresponding pumping section and a secondary guide vane assembly having see-through access from an outlet end of the corresponding pumping section, the primary guide vane assemblies and the secondary guide vane assemblies being configured so as to convert tangential flow created by rotation of the impellers into axial flow.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is perspective view of a loop reactor system of the prior art;

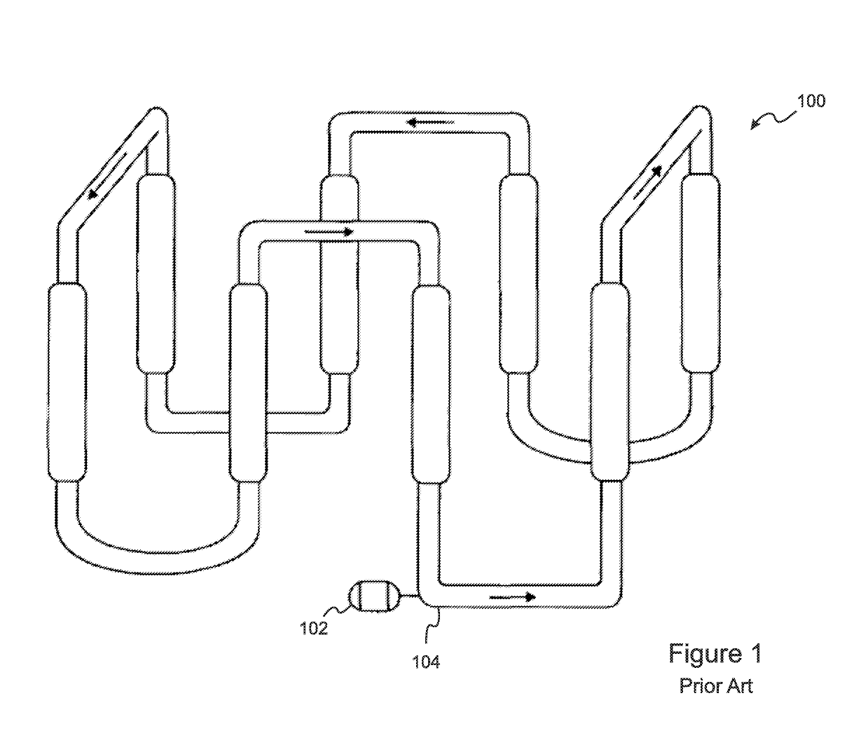

FIG. 2 is cut-away side view of an axial pump installed in an elbow section of a loop reactor of the prior art;

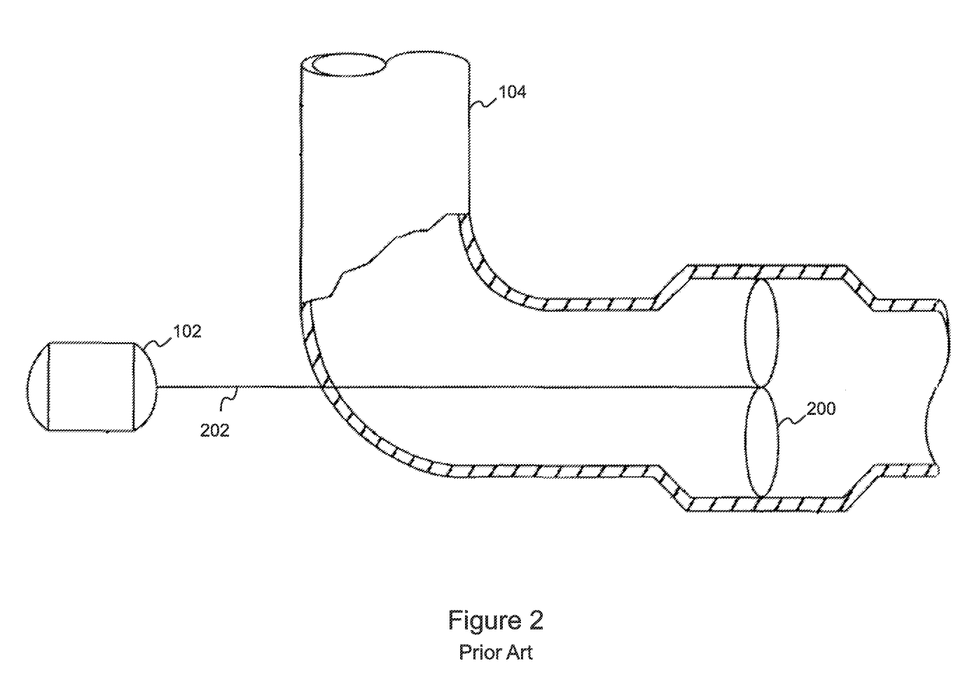

FIG. 3 is a cross sectional side view of a prior art configuration similar to FIG. 2, but including both pre-swirl and outlet guide vanes;

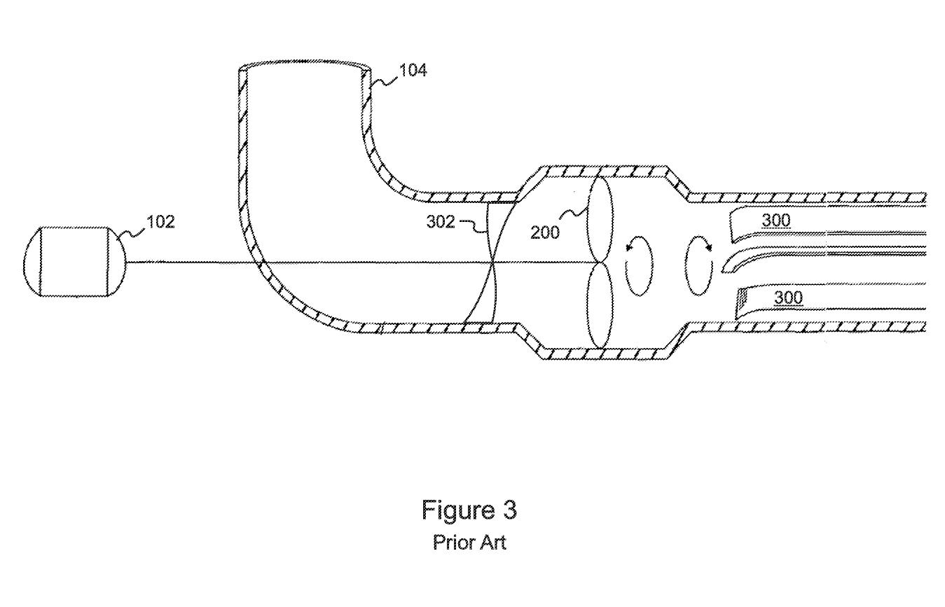

FIG. 4 is a perspective view of a set of prior art pre-swirl guide vanes installed in a pipe section which has been disconnected from the elbow of FIG. 3;

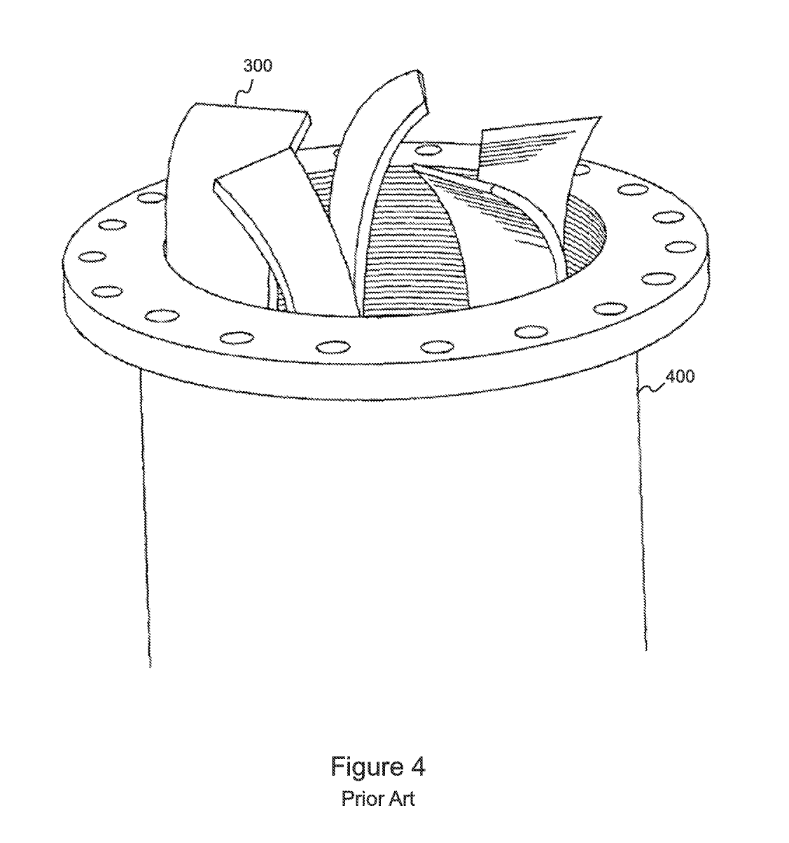

FIG. 5 is a cylindrical projection of a set of straight secondary guide vanes viewed from the side in an embodiment of the present invention;

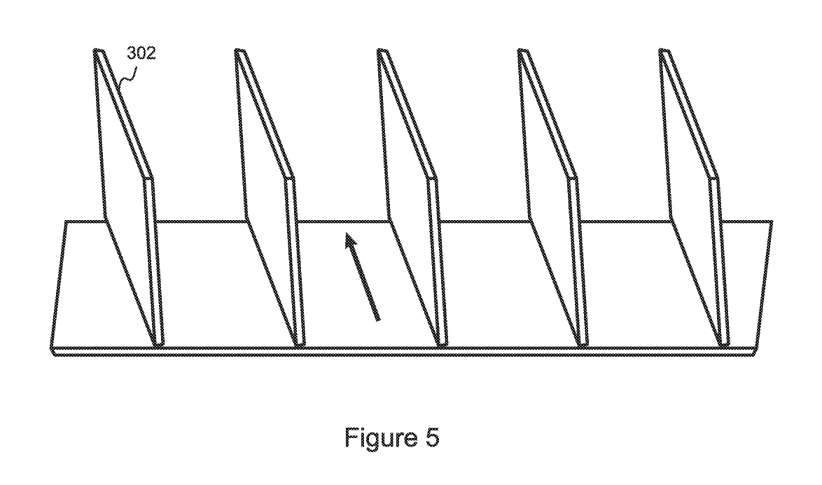

FIG. 6A is a cylindrical projection of a set of curved secondary guide vanes viewed from an angle in an embodiment of the present invention;

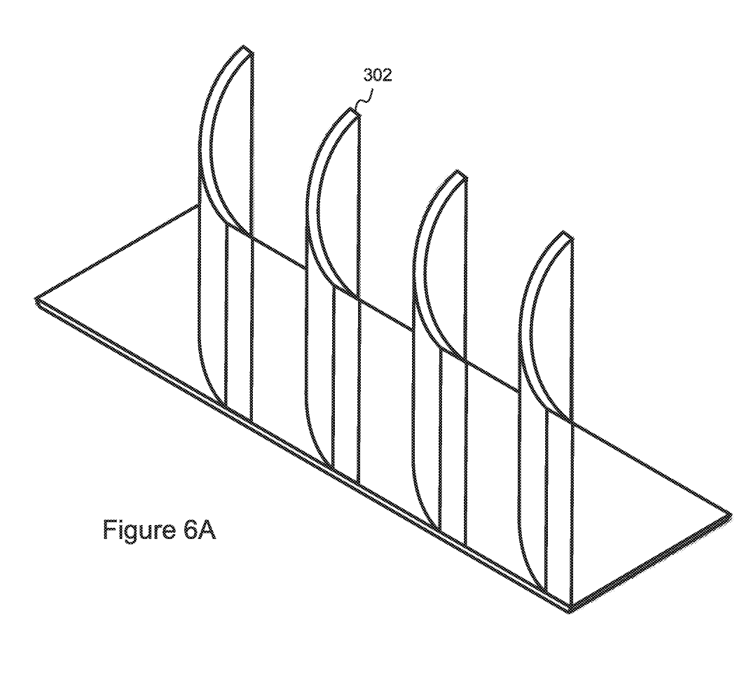

FIG. 6B is an illustration of the cylindrical projection of FIG. 6A viewed from the side;

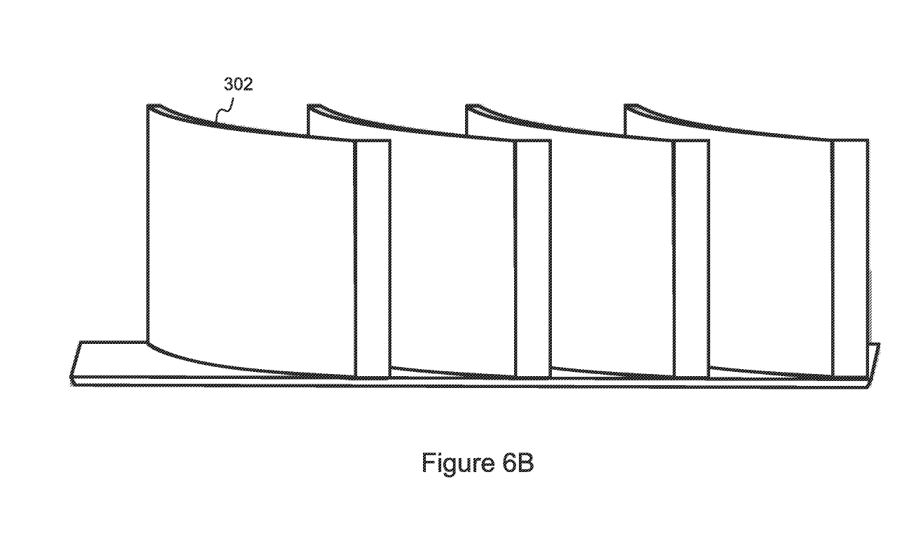

FIG. 7A is a cross sectional schematic view drawn to scale of an elbow-mounted axial pump system in an embodiment of the present invention;

FIG. 7B is a perspective exterior view of the embodiment of FIG. 7B; and

FIG. 8 is a side view of the elbow of FIG. 7B with the pump, shaft, and impeller removed for clarity of illustration, showing the see-through access to the primary and secondary guide vanes.

### DETAILED DESCRIPTION

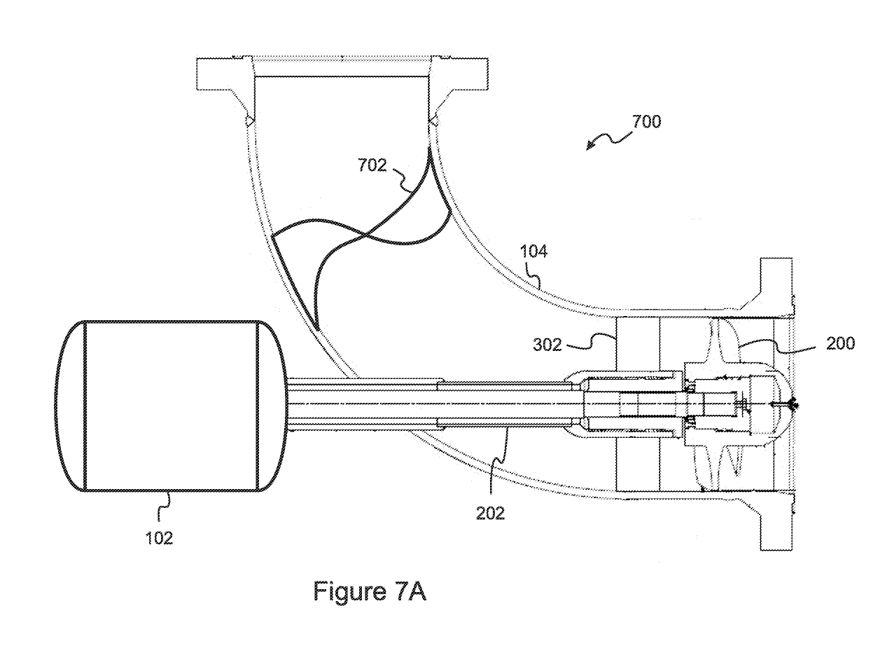

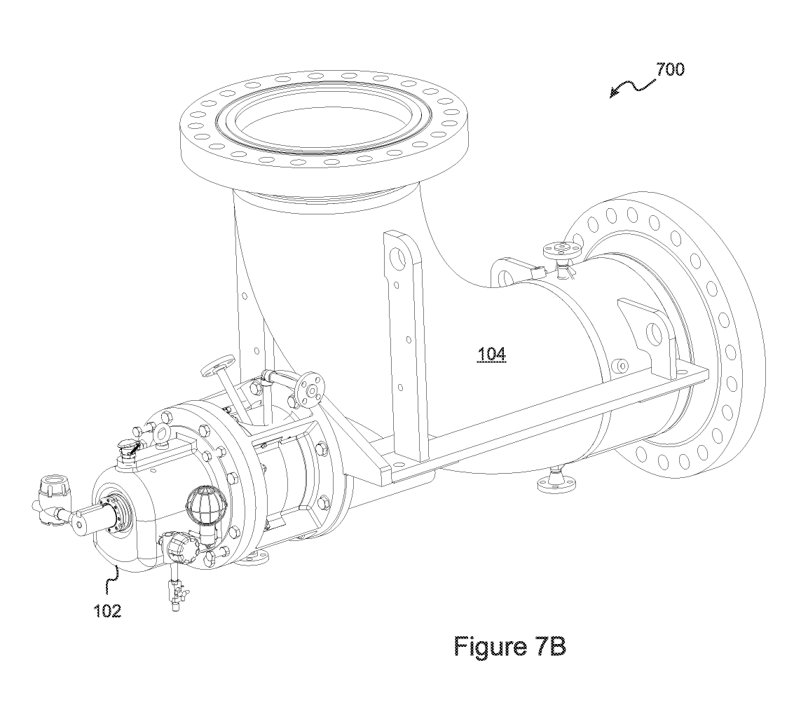

With reference to FIG. 7A, the present invention is an axial pumping system 700 which includes installation of one or more secondary discharge guide vanes 702 in the outlet end of a loop reactor pipe section 104 in addition to the primary guide vanes 302, so as to improve energy efficiency of the pumping system by converting additional tangential flow into axial flow while maintaining “see through” clearance between both the primary 302 and the secondary 702 guide vanes. In the embodiment of FIGS. 7A, the pipe section 104 is an elbow 104, and the primary guide vanes 302 are combined in an assembly with a shaft bearing supporting the pump shaft 202.

FIG. 7B is a perspective view of the exterior of the embodiment of FIG. 7A.

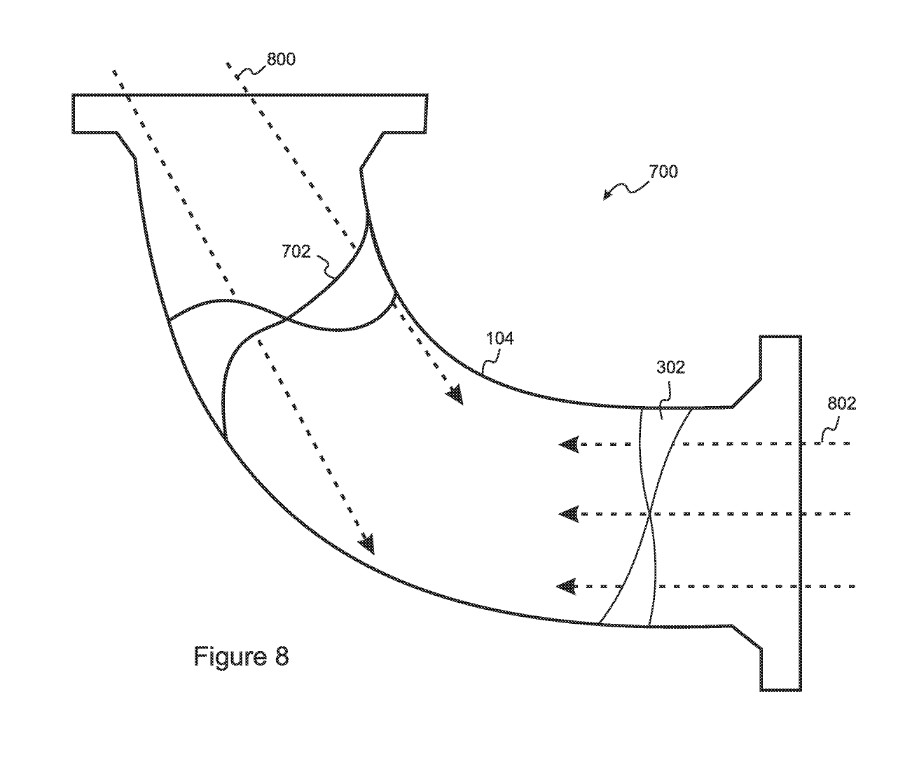

With reference to FIG. 8, the secondary guide vanes 702 have “see through” access 800 from the outlet end of the elbow 104, while the primary guide vanes 302 have “see through” access 802 from the inlet side of the elbow 104.

In some embodiments, the secondary guide vanes 702 of the present invention are straight and redirect the fluid by acting as a barrier that disrupts the tangential fluid motion. In other embodiments, the secondary guide vanes 702 are curved or otherwise shaped. Various embodiments include shaped guide vanes 702 having inlet angles approximating the absolute flow angle of the fluid, which is the actual direction of fluid flow due to both its axial [meridianal] and tangential velocities. Certain embodiments include shaped guide vanes 702 having outlet angles approximating 0 degrees relative to the meridianal axis of the elbow.

It should be noted that the invention is described throughout this paper as being installed in an “elbow” 104, but that the invention applies equally to a straight pipe section, or to a pipe section having any other shape.

Conversion by the present invention of additional tangential flow into axial flow increases the net axial flow velocity. The additional pump head recovered will be proportional to the square of the net velocity increase. Thus, there will be an increase in useful work from the pump without a change in power consumption, yielding an increased efficiency.

Furthermore, quick recovery of the tangential fluid velocity into axial flow by the present invention decreases the friction of polymer particles on the reactor loop and pump sidewalls, thereby reducing the amount of polymer decay and increasing the percentage of useable and saleable product obtained from the reactor.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A pipe-mounted axial pump system, comprising:
a pipe section having an inlet end and an outlet end;
a pump shaft penetrating a wall of the pipe section;
a pump motor located external to the pipe section and coupled to a proximal end of the pump shaft;
a pump impeller mounted on a distal end of the pump shaft and positioned in an inlet region of the pipe section proximal to the inlet end of the pipe section;
a primary guide vane assembly located within the pipe section and having see-through access from the inlet end of the pipe section; and
a secondary guide vane assembly located within the pipe section and having see-through access from the outlet end of the pipe section,
the primary guide vane assembly and the secondary guide vane assembly being configured so as to convert tangential flow created by rotation of the impeller into axial flow.

2. The system of claim 1, wherein the pipe section includes at least one curved portion, and the pump shaft penetrates the wall of the pipe section in the curved portion.

3. The system of claim 2, wherein the pipe section is an elbow pipe section.

4. The system of claim 1 wherein the secondary guide vane assembly includes at least one secondary guide vane that is flat.

5. The system of claim 1, wherein the secondary guide vane assembly includes at least one secondary guide vane that is curved.

6. The system of claim 5, wherein the at least one secondary guide vane has an inlet angle which is approximately equal to an absolute flow angle of fluid propelled to the secondary guide vane by the impeller.

7. The system of claim 5, wherein the at least one secondary guide vane has an outlet angle that is approximately equal to a meridianal axis of the elbow at the secondary guide vane assembly.

8. The system of claim 1, further comprising a pre-swirl guide vane assembly on an inlet side of the impeller.

9. The system of claim 1, wherein the primary guide vane assembly is on an outlet side of the impeller.

10. A loop reactor polymerization system comprising:
a loop reactor including a plurality of pipe sections forming a closed loop of pipe;
a pump shaft penetrating a wall of one of the pipe sections, the penetrated pipe section being referred to herein as the pumping section, the pumping section having an inlet end and an outlet end;
a pump motor located external to the pumping section and coupled to a proximal end of the pump shaft;
a pump impeller mounted on a distal end of the pump shaft and positioned in an inlet region of the pumping section proximal to the inlet end, rotation of the impeller by the pump motor and pump shaft causing fluid to be circulated through the loop reactor;
a primary guide vane assembly located within the pumping section and having see-through access from the inlet end of the pumping section; and
a secondary guide vane assembly located within the pumping section and having see-through access from the outlet end of the pumping section,
the primary guide vane assembly and the secondary guide vane assembly being configured so as to convert tangential flow created by rotation of the impeller into axial flow.

11. The system of claim 10, wherein the pumping section includes at least one curved portion, and the pump shaft penetrates the wall of the pumping section in the curved portion.

12. The system of claim 11, wherein the pumping section is an elbow pipe section.

13. The system of claim 10 wherein the secondary guide vane assembly includes at least one secondary guide vane that is flat.

14. The system of claim 10, wherein the secondary guide vane assembly includes at least one secondary guide vane that is curved.

15. The system of claim 14, wherein the at least one secondary guide vane has an inlet angle which is approximately equal to an absolute flow angle of fluid propelled to the secondary guide vane by the impeller.

16. The system of claim 10, wherein the at least one secondary guide vane has an outlet angle that is approximately equal to a meridianal axis of the elbow at the secondary guide vane assembly.

17. The system of claim 10, further comprising a pre-swirl guide vane assembly on an inlet side of the impeller.

18. The system of claim 10, wherein the primary guide vane assembly is on an outlet side of the impeller.

19. The system of claim 10, wherein the system comprises a plurality of pumping sections penetrated by pump shafts, each of the pump shafts being coupled to a corresponding pump motor external to the corresponding pumping section and an impeller in an inlet region proximal to an inlet end of the corresponding pumping section, each of the corresponding pumping sections containing a primary guide vane assembly having see-through access from the inlet end of the corresponding pumping section and a secondary guide vane assembly having see-through access from an outlet end of the corresponding pumping section, the primary guide vane assemblies and the secondary guide vane assemblies being configured so as to convert tangential flow created by rotation of the impellers into axial flow.
